(19) United States
(12) Patent Application Publication
(10) Pub. No.: US 2012/0238156 A1
(43) Pub. Date: Sep. 20, 2012

(54) TERMINAL BLOCK AND METHOD FOR ASSEMBLING THE SAME

(75) Inventor: Tatsuya Hayashi, Higashine-shi (JP)

(73) Assignee: 3M Innovative Properties Company

(21) Appl. No.: 13/486,088

(22) Filed: Jun. 1, 2012

Related U.S. Application Data
(63) Continuation of application No. 13/132,144, filed on Jun. 1, 2011, now Pat. No. 8,210,865.

(30) Foreign Application Priority Data
Dec. 25, 2008 (JP) 2008-331276

(51) Int. Cl. H01R 4/52

(52) U.S. Cl. 439/820

(57) ABSTRACT

To provide a terminal block having a structure for facilitating the mounting operation of a coil spring to the terminal block, and a method for assembling the terminal block.

A spring supporting part 25a has a supporting surface 251a in which one end of a coil spring 5a contacts, and a spring end holding portion 252a for preventing the end of the coil spring contacting supporting surface 251a from displacing in the radial direction of the coil spring. Spring end holding portion 252a extends form supporting surface 251a and is arranged at a part of the periphery of supporting surface 251a, such that spring end holding portion 252a does not block a slit 27a. The width of slit 27a is smaller than an outer diameter of coil spring 5a, and the length of slit 27a is preferably equal to or larger than the radius of coil spring 5a.

### CROSS REFERENCE To RELATED APPLICATIONS

This application is a continuation of U.S. application Ser. No. 13/132,144, filed Nov. 20, 2009, now pending, the disclosure of which is incorporated by reference in its entirety herein.

### TECHNICAL FIELD

The present invention relates to a terminal block such as a push-type terminal block having a lever and a method for assembling the terminal block.

### BACKGROUND

A so-called push-type terminal block has a push-type lever, an insertion hole and a connecting terminal therein. A cable conductor or a lead terminal attached to an end of a cable may be inserted into the insertion hole and connected to the connecting terminal. Such a push-type terminal block is, for example, used on the back side of an audio instrument and, in many cases, a plurality of the terminal blocks are aligned. For example, Japanese Unexamined Patent Publication (Kokai) No. 7-183059 describes that “When a lead “A” is connected to a first clamp portion 20, as shown in FIG. 3(b), a lever 3 is inclined on a seat member 2 about a rear edge 15a of a pressure contact portion 15 in order to raise a sliding shaft 4. Therefore, first and second holes 5 and 13 are aligned and lead “A” may be inserted into holes 5 and 13″.

A terminal block, having a movable portion such as a lever, usually has a coil spring for biasing the lever in a certain direction. For example, Japanese Unexamined Patent Publication (Kokai) No. 3-147216 describes that “As shown in FIG. 3( [symbol] ), a spring stopper plate 11 has a raised portion 22 on which a rear end of a coil spring 8 is hooked, and then, as shown in FIG. 3( [symbol] ), spring stopper plate 11 is bent so that the plate closes a spring insertion hole 9 of a case 1, whereby raised portion 22 pushes coil spring 8 forward”.

Japanese Unexamined Patent Publication (Kokai) No. 61-136431 describes that “As shown in FIG. 3, when a return spring 15 is assembled in a direction C, return spring 15 may be smoothly assembled without being jammed in a gap D, by means of a projecting column 21 arranged in a containing portion 14”.

In recent years, a terminal block such as a push-type terminal block is required to be more compact because an apparatus including the terminal block becomes downsized and complicated. Therefore, each component constituting the terminal block is inevitably required to be downsized. Concretely, a push lever for opening an insertion hole of each terminal and a coil spring which biases the push lever in the anti-push direction are required to be more compact. On the other hand, the lever and the coil spring are usually assembled manually, therefore, such compact lever or coil spring makes such a manual working troublesome. In particular, the coil spring is usually compressed when it is positioned in a housing and engaged with the lever. The compressed spring may be undesirably apart from a hand of an operator due to a repulsive force of the spring.

### SUMMARY

The present invention thus provides a terminal block having a structure by which a coil spring may be easily assembled in the terminal block, and a method of assembling the terminal block.

In order to achieve the object of the invention described above, one aspect of the present invention provides a terminal block comprising: a housing; at least one lever member movably arranged on the housing; at least one coil spring positioned in the housing, the at least one coil spring being configured to bias the at least one lever member in a certain direction; a spring supporting part configured to support one end of the coil spring; an opening formed in the housing for inserting the coil spring into the housing; and a slit communicated with the opening of the housing, the slit extending in at least a portion of the spring supporting part and having the width which is smaller than an outer diameter of the coil spring.

Another aspect of the present invention provides a method for assembling a terminal block, the method comprising the steps of: providing a housing having at least one lever member movably arranged on the housing; providing a jig having a holding member capable of holding one end of a coil spring which biases the at least one lever member in a certain direction in the housing; engaging one end of the coil spring with the holding member of the jig; inserting the coil spring into the housing through an opening formed in the housing; engaging the other end of the coil spring with a portion of the lever member in the housing; compressing the coil spring by pushing the jig into the housing; moving the jig such that the holding member is positioned in a slit formed in the housing while the coil spring is compressed, the slit being communicated with the opening of the housing, the slit extending in at least a portion of a spring supporting part configured of the housing to support the one end of the coil spring, and having the width which is smaller than an outer diameter of the coil spring; and drawing out the jig from the housing while the holding member of the jig is positioned in the slit such that the one end of the coil spring contacts the spring supporting part of the housing.

According to the present invention, even when a terminal block is downsized, a coil spring which biases a lever may be easily and assuredly attached to or detached from the terminal block.

### BRIEF DESCRIPTION OF THE DRAWINGS

FIG. 1 A perspective view showing a push-type terminal block according to one embodiment of the present invention.

FIG. 2 A bottom view of the terminal block of FIG. 1.

FIG. 3 A cross sectional view along III-III line of FIG. 2.

FIG. 4 A top view of the terminal block of FIG. 1.

FIGS. 5-5B FIG. 5 is a side view, FIG. 5A is a cross sectional view along A-A line of the side view, and FIG. 5B is a cross sectional view along B-B line of a housing of terminal block of FIG. 1.

FIG. 6 A view showing a coil spring and an embodiment of a jig for mounting the coil spring to the terminal block.

FIG. 7 A view showing the state that the jig holding the coil spring is moved close to an opening in the bottom of the housing of the terminal block.

FIG. 8 A view showing the state that the jig is inserted into the bottom opening so as to engage one end of the coil with a protrusion of a lever member.

FIG. 9 A view showing the state that the jig is further inserted so as to compress the coil spring.

FIG. 10 A view showing the state that jig is pivoted so that the jig enters a slit formed in the bottom of the housing while keeping the coil spring compressed.

FIG. 11 A view showing the state that the jig is withdrawn so that the other end of the coil spring comes into contact with a spring supporting part of the housing.

FIG. 12 A view showing the state that the mounting operation for the coil spring is completed.

FIGS. 13-13B FIG. 13 is a side view, FIG. 13A is a cross sectional view along A-A line of the side view, and FIG. 13B is a cross sectional view along B-B line of a housing of a terminal block according to a modification of the terminal block as shown in FIG. 1.

### DETAILED DESCRIPTION

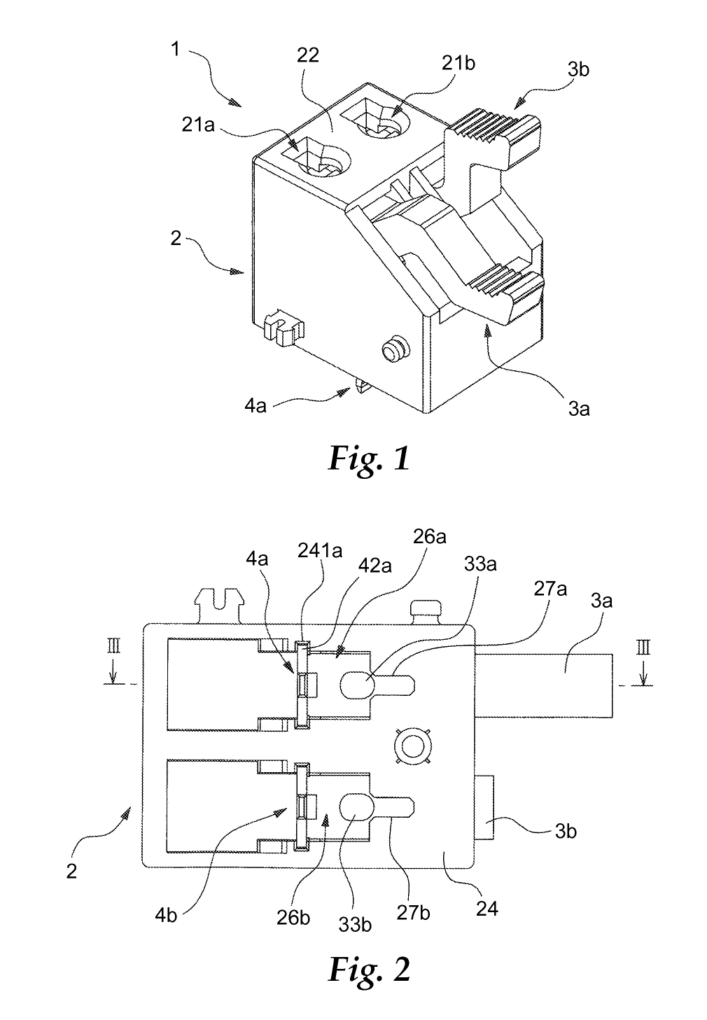

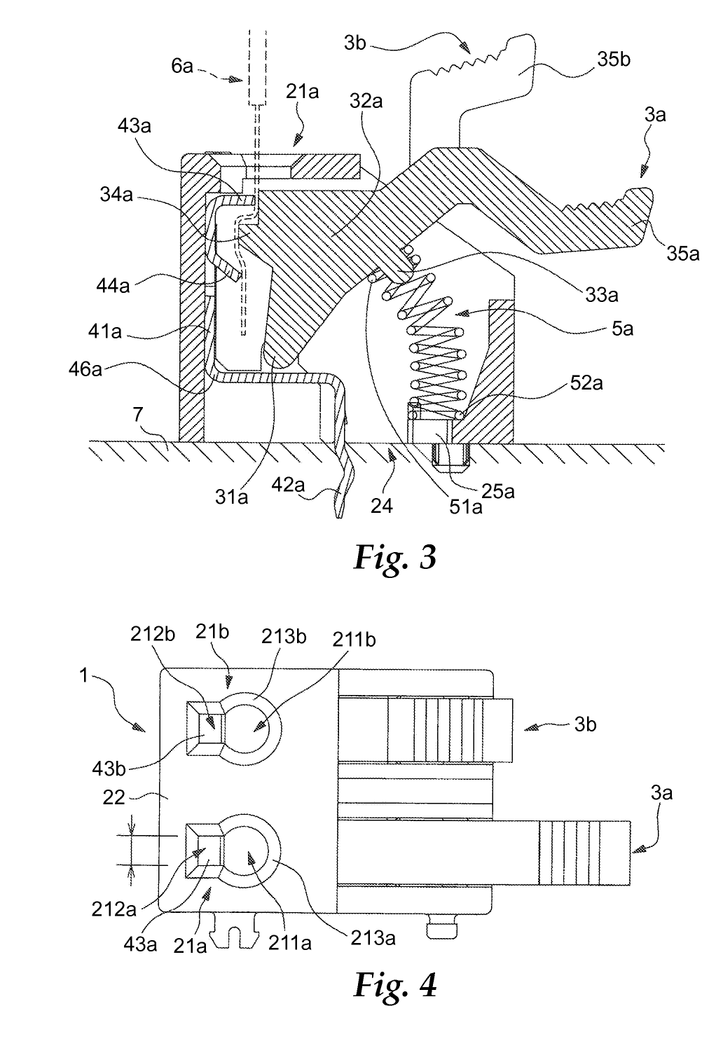

FIG. 1 is a perspective view of a preferable embodiment of a push-type terminal block 1 (hereinafter, merely referred to as “terminal block”). FIG. 2 is a view showing terminal block 1, and FIG. 3 is a cross sectional view along a III-III line of FIG. 2. Terminal block 1 has a housing 2, first and lever members 3a and 3b movably arranged on housing 2, first and second connecting terminals 4a and 4b made from conductive material (as for second terminal 4b, a part of which is shown in FIG. 2), and first and second biasing members or coil springs which bias first and second lever members 3a and 3b, respectively (only first biasing member 5a is shown in FIG. 3). Housing 2 may be made from arbitrary material such as metal or resin. As shown in FIG. 1, housing 2 has insertion holes 21a and 21b at a top surface 22 thereof, through which a cable conductor or a lead terminal attached to an end of a cable to be connected to each connecting terminal in the housing (hereinafter, merely referred to as “lead”) ma be inserted.

As shown in FIG. 3, first connecting terminal 4a may be made by bending and/or punching a metal plate such as a copper sheet. First connecting terminal 4a has generally a L-shape provided with a back side portion 41a and a bent leg portion 42a. By engaging leg portion 42a with a groove portion 241a (see FIG. 2) formed on a bottom part 24 of housing 2, first connecting terminal 4a may be fixed to housing 2. Connecting terminal 4a further has two projections 43a and 44a for contacting a first lead 6a (shown in FIG. 3 by a dashed line) inserted into through hole 21a. Projections 43a, 44a may be formed by bending and/or punching a part of the metal plate and are separated from each other by a certain distance in the longitudinal direction of first lead 6a. Leg portion 42a of terminal 4a projects from bottom part 24 of housing 2 (or a housing surface connected to a substrate 7 as schematically shown in FIG. 3), and may be electrically connected to a through hole (not shown) formed on substrate 7 by soldering, etc. Alternatively, leg portion 42a of the connecting terminal may be bent such that the leg portion extends parallel to the substrate for performing surface mounting, and the leg portion may be electrically connected to a conductive part (or a land) on the substrate by soldering, etc. The other connecting terminal 4b may have the same configuration as first connecting terminal 4a.

As shown in FIG. 3, first lever member 3a is configured to pivot about a support shaft 31 a thereof. Support shaft 31 a is positioned near and inside a bend portion 46a of connecting terminal 4a having generally a L-shape. First lever member 3a has a body part 32a extending from support shaft 31a and opposite to terminal 4a, and a protrusion 33a formed on body part 32a and apart from shaft 31a in the longitudinal direction of the lever member. First biasing member 5a such as a coil spring has one end 51a engaged with protrusion 33a and opposite end 52a received in a spring supporting part 25a formed on bottom part 24 of housing 2. Coil spring 5a biases lever member 3a (upward in FIG. 3) such that a wedge part 34a of lever member 3a, formed near two projections 43a, 44a of first connecting terminal 4a, is positioned between the two projections. The expression “positioned in the housing” or the like herein means not only that the coil spring is completely contained in the housing, but also that only a part of the coil spring is positioned within the housing. For example, a part of the coil spring may project from a surface of the housing, otherwise, the coil spring may not be substantially covered by the housing since the area of wall portions of the housing is very small (in other words, the housing has many openings).

Second lever member 3b and a second coil spring (not shown) which biases second lever member 3b may have the same constitutions as first lever member 3a and first coil spring 5a, respectively. In the illustrated embodiment, in order to prevent an operator from undesirably contact second lever member 3b when the operator should contact only first lever member 3a, the positions of an operating part 35a of first lever member 3a and an operating part 35b of second lever member 3b are different when the operator does not contact both operating parts, as shown in FIG. 3.

FIG. 4 is a top view of terminal block 1. Insertion holes 21a and 21b have cable through parts 211a and 211b, probe through parts 212a and 212b communicated with the cable through parts, respectively. Cable through parts 211a and 212b are generally circular through holes having inclined surfaces 213a and 213b, respectively, at one end thereof near top surface 22. The diameter of each cable through part is somewhat larger than the outer diameter of the cable to be inserted in to the cable through part. On the other hand, the probe through parts are generally rectangular holes each having the width W which is smaller than the diameter of the cable through part. The width W may be smaller than the diameter of a conductor of the cable inserted into the through hole. Within housing 2 just below insertion holes 21a and 21b, projections 43a and 43b of connecting terminals 4a and 4b are positioned. Viewed from the top surface of housing 2, the front end of each projection is positioned generally on the circumference of the circular through hole.

While the cable is inserted in to the through hole, a probe of a tester or the like may be inserted into each of probe through parts 212a and 212b and connected to the projection of the connecting terminal, whereby a conductive state between terminal block 1 and the cable connected to terminal block 1 may be examined. Since the width W is smaller than the diameter of the cable through part, the front end of the cable is not likely to be accidentally inserted into the probe through part when the cable should be inserted into the cable through part. Therefore, the workability of inserting the cable may be enhanced. If the width W is smaller than the diameter of the conductor of the cable, the false insertion of the cable may be more effectively prevented. Further, since the cable through part is visually larger than the probe through part, the operator can easily identify the cable through part from the probe through parts.

As shown in FIG. 2, an opening 26a through which terminal 4a and coil spring 5a are inserted so as to position them in housing 2, and an opening 26b through which terminal 4b and a coil spring (not shown) are inserted so as to position them in housing 2, are formed at bottom part 24 of housing 2. Further, a slit or a concave portion 27a which is communicated with opening 26a and generally straightly extends in spring supporting part 25a, and a slit or a concave portion 27b which is communicated with opening 26b and generally straightly extends in spring supporting part 25b, are formed bottom part 24. Although slit 27a generally straightly extends over the center of spring supporting part 25a, it is sufficient that the front end of slit 27a reaches spring supporting part 25a. In addition, slit 27a may not straightly extend, for example, may extend like an L-shape or an S-shape.

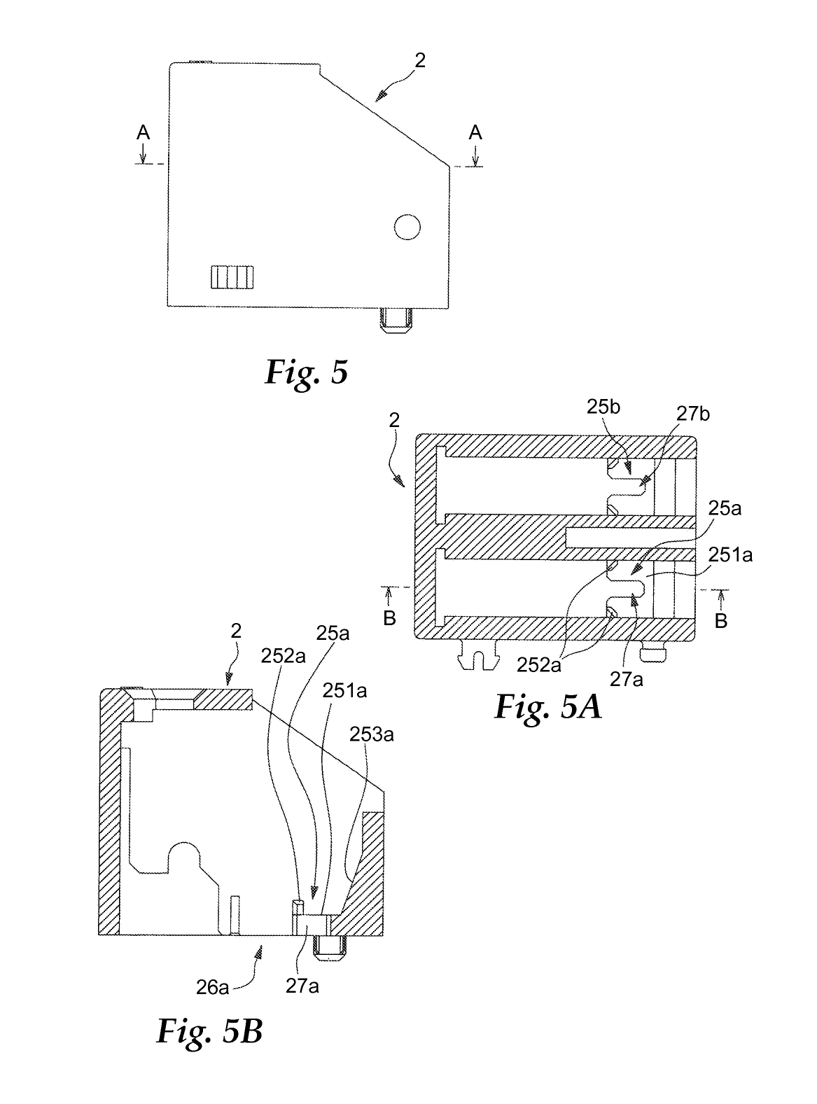

FIGS. 5, 5A, and 5B show a part drawing of housing 2 and two cross sectional views thereof Spring supporting part 25a has a supporting surface 251a which contacts one end 52a of coil spring 5a (FIG. 3), and a spring end holding portion 252a which holds coil spring end 52a such that the end does not offset in the radial direction of the coil spring. For example, spring end holding portion 252a generally vertically extends from supporting surface 251a and arranged at a part of the periphery (two positions in the illustrated embodiment) of supporting surface 251a such that spring end holding portion 252a does not block slit 27a. The width of slit 27a is smaller than the outer diameter of coil spring 5a, and the length of slit 27a is preferably equal to or larger than the radius of coil spring 5a. Since spring supporting part 25b and slit 27b may be the same as spring supporting part 25a and slit 27a, respectively, the detailed explanation thereof is omitted. Spring supporting part 25a may have a wall portion 253a adjacent to supporting surface 251a and positioned generally opposite to slit 27a, whereby wall portion 253a may also have the holding function for the coil spring end. As an alternative to spring end holding portion 252a as shown in FIG. 5B, a protrusion (not shown), which projects from generally the center of supporting surface 251a and have the dimension smaller than the inner dimension of coil spring 5a (i.e., the protrusion may be inserted into the end of the coil spring), may be arranged.

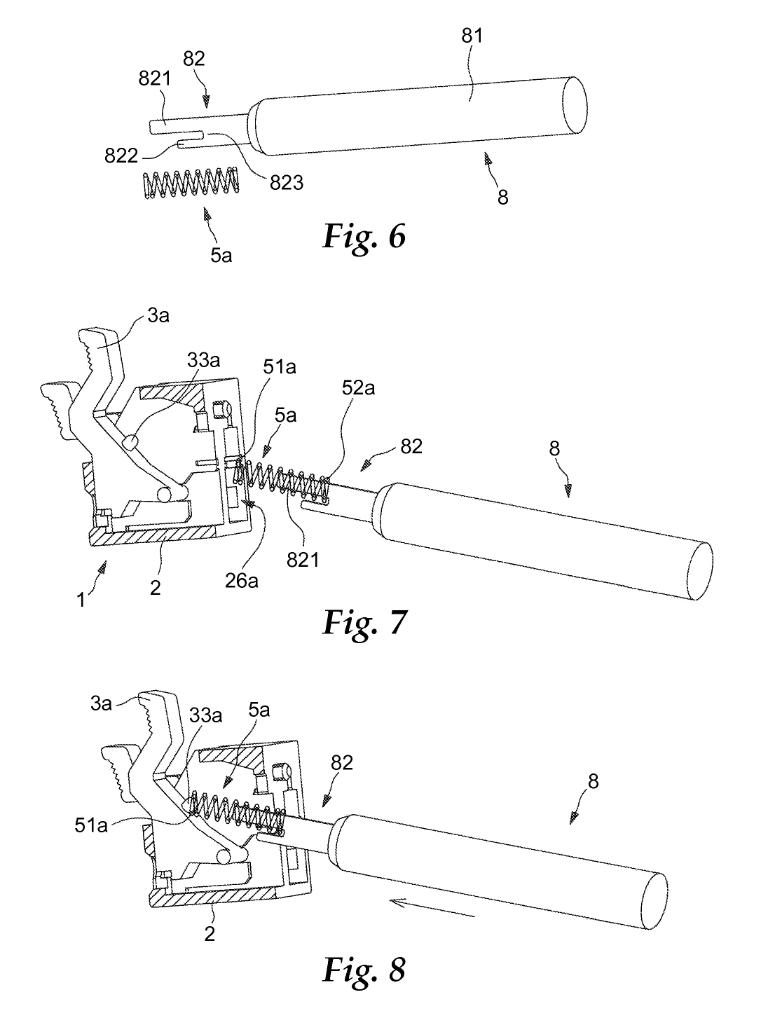

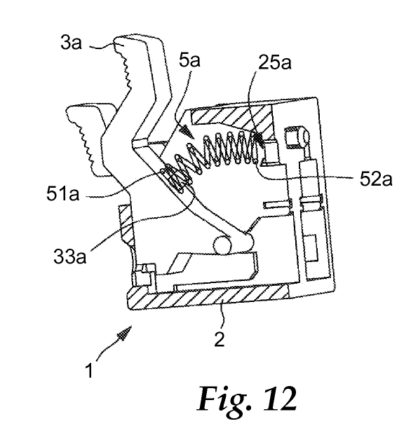

Next, with reference to FIGS. 6 to 12, the procedure for assembling the coil spring with the terminal block of the invention will be explained. Although the explanation below relates to coil spring 5a used for biasing first lever 3a, the same explanation may be applied to the coil spring used for biasing second lever 3b.

First, as shown in FIG. 6, a jig 8, used for mounting coil spring 5a in housing 2 of terminal block 1, is provided. Jig 8 has a shaft part 81, preferably having a rod-shape, configured to be gripped by an operator, and a holding part 82 attached to one end of shaft part 81 configured to hold coil spring 5a. Holding part 82 is a plate member having generally U-shape or J-shape. In particular, holding part 82 has a first projection 821 having the width smaller than the inner diameter of coil spring 5a and the length smaller than the length of coil spring 5a, a second projection 822 positioned apart from first projection 821 by at least a wire diameter of coil spring 5a, and a bottom portion 823, arranged between the first and second projections, configured to contact one end 52a of coil spring 5a when first projection 821 is inserted into coil spring 5a. The projecting length of second projection 822 is preferably smaller than the length of first projection 821, in view of operability of the procedure as described below. Holding part 82 is totally constituted by a member having the thickness smaller than the width of slit 27a. In addition, as second projection 822 is not essential, holding part 82 may have generally a rod-shape.

Then, as shown in FIG. 7, while coil spring 5a is held by holding part 82 of jig 8 (concretely, projection 821 of jig 8 is inserted into coil spring 5a), the operator moves holding part 82 of jig 8 close to bottom opening 26 of housing 2 of terminal block 1.

Further, as shown in FIG. 8, coil spring 5a is inserted into opening 26 with holding part 82, until one end 51a of coil spring 5a engages protrusion 33a of first push lever 3a. Although the shape of protrusion 33a is not limited to a dome or hemisphere as illustrated, the shape of protrusion 33a is preferably determined so that the position of coil spring end 51a is not substantially changed while the coil spring engages the protrusion. Alternatively, lever member 3a may have a recess at the position of protrusion 33a, whereby the coil spring end may be inserted in to the recess.

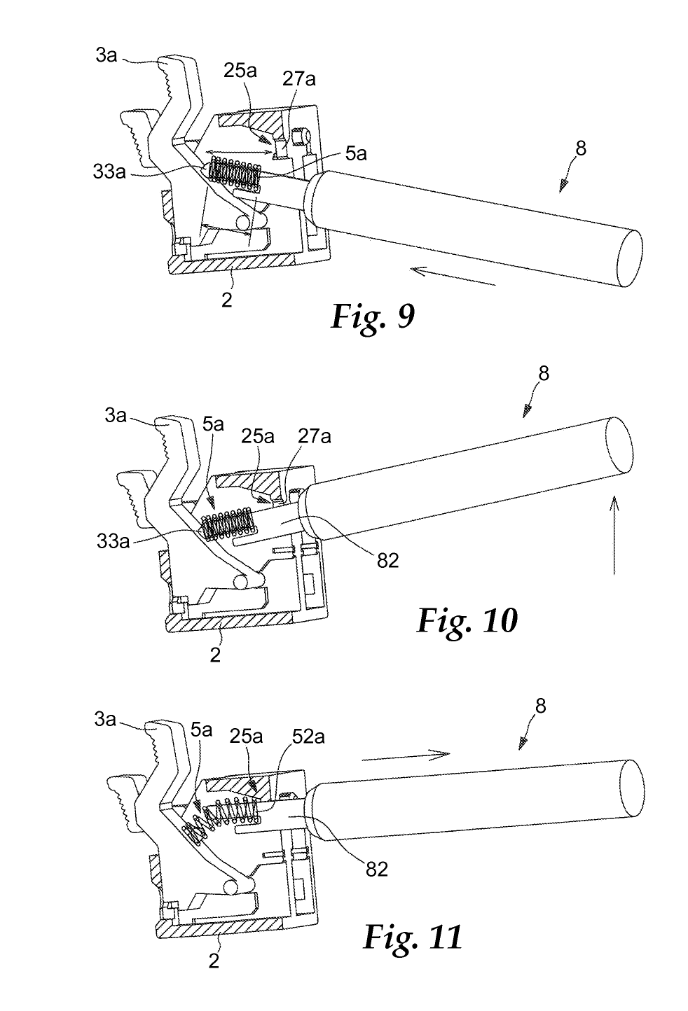

Next, as shown in FIG. 9, jig 8 is further pushed from the state of FIG. 8 so that coil spring 5a is compressed. At this point, jig 8 is pushed at least until a length L1 of the compressed coil spring becomes smaller than a distance L2 between spring supporting part 25a and protrusion 33a.

Then, as shown in FIG. 10, while keeping coil spring 5a compressed, jig 8 is pivoted about protrusion 33a toward spring supporting part 25a. At this point, holding part 82 of jig 8 is inserted into slit 27a formed at the bottom of housing 2.

Next to the state of FIG. 10, jig 8 is pulled from housing 2 so as to restore compressed coil spring 5a, as shown in FIG. 11. At this point, jig 8a is withdrawn so that holding part 82 of jig 8 passes through slit 27a of housing 2 in order that one end 52a of restored coil spring 5a comes into contact with supporting surface 251a of spring supporting part 25a (see FIG. 5). As described above, the width of slit 27a is larger than the width of holding part 82 and smaller than the outer diameter of the coil spring. Therefore, only jig 8 may be smoothly withdrawn by passing holding part 82 through slit 27a. Further, as shown in FIG. 5, since spring supporting part 25a has spring end holding portion 252a adjacent to the periphery of coil spring 5a, the position of coil spring 5a after it is supported by supporting part 25a is prevented from offsetting.

Due to the explained procedure, coil spring 5a may be assembled in a predetermined state: i.e., one end 51a of the coil spring engages protrusion 33a of lever member 3a and the other end 52a of the coil spring engages spring supporting part 25a of housing 2. When coil spring should be detached from housing 2, the procedure as explained in FIGS. 7 to 11 should be executed in reverse order.

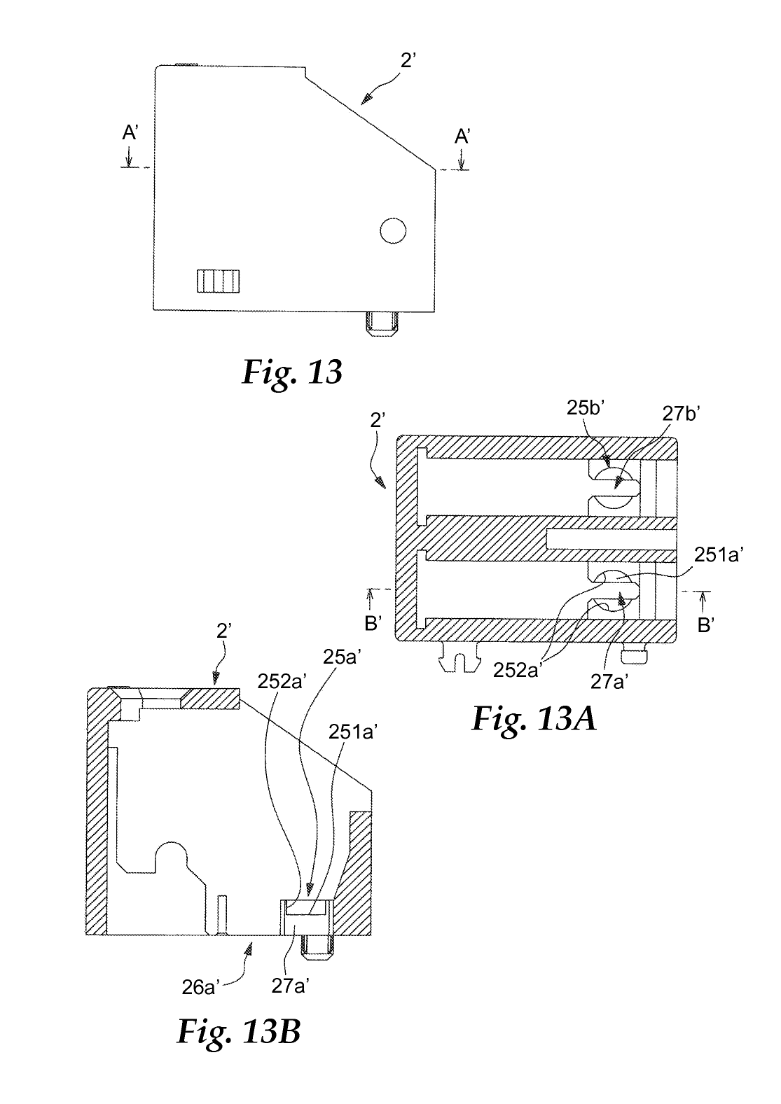

FIGS. 13, 13A, and 13B show another embodiment of the spring supporting part formed in the housing. FIGS. 13, 13A, and 13B include a part drawing of a housing 2′ and two cross sectional views thereof. A spring supporting part 25a′ has a supporting surface 251a′ which contacts one end 52a of coil spring 5a (FIG. 3), and a spring end holding portion 252a′ which holds coil spring end 52a such that the end does not offset in the radial direction of the coil spring. For example, spring supporting part 25a′ is a circular recess, having the diameter slightly larger than the outer diameter of the coil spring, formed near the bottom of housing 2′. In this case, supporting surface 251a′ and spring end holding portion 252a′ correspond to bottom and side surfaces of the circular recess, respectively. A slit or a concave portion 27a′, communicated with an opening 26a′ of housing 2′, generally straightly extends in the circular recess. Also in this case, spring end holding portion 252a′ generally vertically extends from supporting surface 251a′ and arranged at a part of the periphery of supporting surface 251 a′ such that spring end holding portion 252a′ does not block slit 27a′. The width of slit 27a′ is smaller than the outer diameter of coil spring 5a. Although it is sufficient that the front end of slit 27a′ reaches spring supporting surface 251a′, the length of slit 27a′ is preferably equal to or larger than the radius of coil spring 5a, in view of workability and/or the strength of the jig. Since spring supporting part 25b′ and slit 27b′ may be the same as spring supporting part 25a′ and slit 27a′, respectively, the detailed explanation thereof is omitted.

In the illustrated embodiment, terminal block 1 has two connecting terminals, two lever members and two biasing members or coil springs. However, the terminal block may have one connecting terminal, one lever member and one coil spring, or, three or more connecting terminals, three or more lever members and three or more coil springs.

1. A terminal block comprising:
a housing;
a lever member movably arranged on the housing;
a biasing member positioned in the housing and configured to bias the lever member in a certain direction; and
a slit formed in the housing for mounting the biasing member in the housing, the slit having a width smaller than an outer diameter of the biasing member.

2. The terminal block of claim 1, wherein the biasing member comprises a spring coil.

3. The terminal block of claim 1, wherein the biasing member is mounted in the housing by positioning a holding member in the slit.

4. The terminal block of claim 1 further comprising a conductive connecting terminal comprising projections for contacting a lead that is inserted in the housing.

5. The terminal block of claim 4, wherein the lever member comprises a wedge part configured to be positioned between the projections.

6. The terminal block of claim 1, wherein the slit has a length that is equal to or larger than a radius of the biasing member.
